(19) United States
(12) Patent Application Publication
(10) Pub. No.: US 2010/0001522 A1
(43) Pub. Date: Jan. 7, 2010

(54) ROCK-DRILLING TOOL, A DRILL ROD AND A COUPLING SLEEVE

(75) Inventors: Bo Carlström, Sandviken (SE); Johan Lindén, Gavle (SE)

Correspondence Address: DRINKER BIDDLE & REATH (DC), 1500 K STREET, N.W., SUITE 1100, WASHINGTON, DC, 20005-1209, US

(73) Assignee: Sandvik Intellectual Property AB, Sandviken (SE)

(21) Appl. No.: 12/300,957

(22) PCT Filed: May 15, 2007
(86) PCT No.: PCT/SE07/00468

§ 371 Date: Aug. 31, 2009

(30) Foreign Application Priority Data
May 17, 2006 (SE) 0601117-5
May 17, 2006 (SE) 0601119-1

(51) Int. Cl. E21B 17/042; F16L 15/00; F16L 15/08; F16L 21/00; E21B 17/04

(52) U.S. Cl. 285/392; 175/320; 285/417

(57) ABSTRACT

In a first aspect, the invention relates to a rock-drilling tool that comprises a drill rod (1;1″′) having a male thread (5;5′), and a coupling sleeve (7:7′) having a female thread (15:15′) for the co-operation with the male thread of the drill rod. The male thread (5;5′) of the drill rod (1;1′) may consist of a martensitic, stainless steel. The coupling sleeve consists of hardened low-alloy steel. Axially inside the male thread (5;5′), a waist (32;32′) is formed in which the drill rod (1;1′) has the smallest diameter thereof. The male thread (5;5′) has a wear volume that is larger than the wear volume of the female thread (15; 15′). Furthermore, the invention relates to a drill rod per se as well as a coupling sleeve per se.

### TECHNICAL FIELD OF THE INVENTION

In a first aspect, this invention relates to a rock-drilling tool intended for top hammer drilling and of the type that comprises a drill rod having a male thread and a coupling sleeve having a female thread for the co-operation with the male thread of the drill rod.

In other aspects, the invention also relates to a drill rod as well as a coupling sleeve for such rock-drilling tools.

### BACKGROUND OF THE INVENTION

Many types of equipments for practical rock drilling comprise, on one hand, a stationary placed machine having a shank adaptor, and on the other hand a drilling tool in the form of a drill bit of some type and at least one drill rod or a MF rod as well as a coupling sleeve for the connection of the drill rod with the shank adaptor, such as is illustrated in FIG. 8. Furthermore, the drill rod connected to the shank adaptor may be connected with one or more additional rods while forming a longer drill string for drilling deeper holes. In top hammer drilling, the shank adaptor is arranged to provide a combination of impact and rotary motions, which are transferred to the bit via the drill rod or the string.

In rock-drilling equipment in general and equipment for top hammer drilling in particular, high requirements of technical as well as economic character are made. In a technical respect, the drilling tool should be capable of drilling the straightest possible holes fast and efficiently in rocks having most varying properties. Of economical interest to the user is not only the technical performance of the newly manufactured drilling tool, but to a great extent also the service life thereof. This depends on a number of different factors, one of which is the capacity of the drill to resist corrosion fatigue. Such fatigue, which may result in rupture of the drill rod, arises when the same, during the work thereof of transferring the impact and rotary motions to the bit, is subjected to corrosive attacks, which in combination with pulsating loads in the form of shock waves and bending motions, initiate cracks, which gradually grow large finally resulting in fatigue. Particularly sensitive to crack formation are the thread-groove bottoms in the male thread of the drill rod, where the drill rod has a small cross-sectional area. Another service life-determining factor is the inevitable wear of the threads that arises when the flanks thereof wear against each other as a result of the intermittently repetitive, axial impulsive forces, as well as the relative rotary motion that constantly is active when the torque is transferred between the coupling sleeve and the drill rod. Thus, in contrast to rigidly tightened threaded joints of the conventional type, the severely exposed threaded joint of a rock drill is dependent on the fact that the torque transfer between the coupling sleeve and the drill rod provides a “constant” screwing-in of the male thread into the female thread, which leads to wear of primarily the flanks of the threads that tighten the joint. The thread wear becomes particularly troublesome in economical respect if the male thread of the drill rod is worn out faster than the female thread of the coupling sleeve, since this requires replacement of the expensive drill rod before the requisite replacement of the cheaper coupling sleeve. An additional factor of importance to the service life of the drill as well as the technical performance thereof, is the capacity of the threaded joint to counteract deflection, i.e., the tendency of the drill rod to deflect or turn out at an angle to the coupling sleeve. Ideally, the drill rod and the coupling sleeve should extend along a common centre axis (in extension of the shank adaptor) in order to guarantee that the drilled hole becomes desirable straight. The further the wear of the threads proceeds, the more the stiffness is deteriorated and the play is increased in the joint between the coupling sleeve and the drill rod, the deflection phenomena propagating into the threaded joint and accelerating the wear.

The problem of premature wear of the male thread of the threaded joint between a drill rod and a coupling sleeve has been observed by U.S. Pat. No. 6,196,598 (SE 521790), more precisely by the fact that the male thread is designed with a wear volume (proportional to the cross-sectional area) that is from 5 to 25% larger than the wear volume of the female thread. In such a way, it is guaranteed that the comparatively expensive drill rod does not need to be discarded and be replaced before the cheaper female thread of the coupling sleeve has been worn out. However, this measure solves neither the problem of corrosion fatigue nor the problem of successively growing play and deflection.

### OBJECTS AND FEATURES OF THE INVENTION

The present invention aims at obviating at least a part of the above-mentioned shortcomings of the known rock-drilling tool and at providing an improved tool. Therefore, a primary object of the invention is to provide a rock-drilling tool adapted for practical top hammer drilling, which has optimal properties in respect of technical performance as well as economic attractiveness, above all by being able to offer a long service life and a persistently reliable serviceability during the entire active service life thereof. Thus, the user should not only be able to count on the drill rod to last at least as long as the coupling sleeve, but also to efficiently and in the long term resist, on one hand, according to one aspect of the invention, the tendencies to corrosion fatigue, and on the other hand the deflection phenomena that increase the thread play that inevitably arises during practical drilling in rocks of varying structure. An additional object is to provide a rock-drilling tool that is structurally simple and therefore inexpensive to manufacture and easy to use.

According to the invention, at least the primary object is attained by the rock-drilling tool according to the invention by means of the features defined in the characterizing clause of claim 1. Preferred embodiments of the rock-drilling tool are further defined in the dependent claims 2-5.

Furthermore, the invention relates to a drill rod and a coupling sleeve per se. The features of the drill rod according to the invention are seen in the independent claim 6. The features of the coupling sleeve according to the invention are defined in the independent claim 10.

### FURTHER ELUCIDATION OF PRIOR ART

By U.S. Pat. No. 6,547,891, a drill rod intended for top hammer-drilling equipment having a male thread made of a corrosion resistant, martensitic steel is previously known. In this case, the publication does not contain—except for the specified material use—any information about how a drill rod could be optimized in respect of the capability of the male thread to provide a threaded joint free of play.

Threaded joints for rock-drilling tools of different types are further disclosed in SE 9904324-2, SE 0103407-3 and SE 0201989-1.

### BRIEF DESCRIPTION OF THE APPENDED DRAWINGS

The invention will be described closer below, reference being made to the appended drawings, in which the same designations relate to the same parts. Because neither the adaptor to which one of the ends of the drill rod of the tool is connected, nor the bit connected to the opposite end of the drill rod, are of any immediate interest, these components, as the proper drilling machine, have not been shown in the drawings.

Therefore, in the drawings:

FIG. 1 is a side view of a drill rod,

FIG. 2 is an enlarged longitudinal section through a coupling sleeve intended to co-operate with the drill rod,

FIG. 3 is an enlarged view showing the end of the drill rod that co-operates with the coupling sleeve,

FIG. 4 is a cross-section through the drill rod,

FIG. 5 is an extremely enlarged detailed view showing the design of a threaded joint between the drill rod and the coupling sleeve of FIGS. 2 and 3 or FIGS. 6 and 7,

FIG. 6 is an enlarged longitudinal section through an alternative embodiment of a coupling sleeve according to the invention, intended to co-operate with the drill rod,

FIG. 7 is an enlarged view showing an end of an alternative embodiment of a drill rod according to the invention, and

FIG. 8 is an exploded view of a conventional drill string.

### DETAILED DESCRIPTION OF PREFERRED EMBODIMENTS OF THE INVENTION

The drill rod, in its entirety designated 1, comprises opposite ends 2, 3, such as the same are represented by planar, annular end surfaces, and has a length that is many times greater than the diameter thereof. In practice, the rod 1 may have a length of 4-6 m and a largest diameter of about 38 mm. The end 2 is usually called shank end, since the same should always be facing the shank adaptor. In a main section S, which extends along the major part of the total length, the rod has a conventional, hexagonal cross-sectional shape (see FIG. 4), a central flush duct 4 extending through-going from end to end. At a distance from the two ends 2, 3, the hexagonal cross-sectional shape ceases and transforms into generally rotationally symmetrical surfaces in which external threads are formed, i.e., male threads. More precisely, a first male thread 5 is provided adjacent to the end 2, while a second male thread 6 is provided adjacent to the end 3. The last-mentioned thread 6 is intended to be screwed into a female thread in a drill bit or into another coupling sleeve of a conventional type, and is of minor importance.

In this case, the coupling sleeve 7 is exteriorly cylindrical and comprises two hollow spaces 8, 9, which are separated by a partition wall 10, and mouth in opposite ends 11, 12 of the sleeve. The partition wall 10 has an axial thickness L5. Each individual hollow space 8, 9 is delimited by cylindrical wall portions or skirts 13, 14. On the insides of the same, female threads 15, 16 are formed, the first-mentioned one of which is intended to co-operate with the male thread 5 on the rod 1, while the last-mentioned one is intended to co-operate with a male thread on a spigot included in the shank adaptor that has the purpose of driving the drilling tool. The two hollow spaces 8, 9 communicate with each other via a central hole 17, which extends through the partition wall 10.

When the male thread 5 of the rod and the female thread 15 of the sleeve co-operate during operation, the end surface 2 bottoms against the surface 18 of the partition wall 10. Analogously, the end of the adaptor spigot bottoms against the opposite, planar surface 19 of the partition wall 10.

According to the invention, at least the male thread 5 on the drill rod 1 may be manufactured from a martensitic, stainless steel. If so, it is most convenient that the drill rod in its entirety is manufactured from this material, the two male threads 5, 6 being integrated parts of the rod body. Alternatively, such stainless steel ends carrying the male threads may be friction welded to a low-alloy steel rod. The stainless steel may advantageously be of the type disclosed in U.S. Pat. No. 6,547,891, i.e., have a structure comprising primarily martensite and containing at least 10% by weight of chromium (Cr), as well as minute quantities of carbon (C) and nitrogen (N), respectively. The steel may also contain varying quantities of molybdenum (Mo), tungsten carbide (WC), and copper (Cu). The content of martensite should amount to at least 50% by weight, suitably at least 75% by weight.

By making the drill rod of a corrosion resistant alloy, a passive surface layer is obtained as a consequence of the addition of chromium, which layer efficiently counteracts corrosion, above all in the bottoms of the thread grooves. Therefore, in comparison with conventional steels, the corrosion rate is reduced most considerably in the sensitive thread-groove bottoms. Hence, undertaken tests have indicated an increase of at least 50% of the service life (from about 2000 to about 3000 drilled metres).

The positive impact of the stainless material on the service life of the drill rod is consequently irrefutable. However, the desirable corrosion properties have been gained on the expense of the wear resistance of the material. Thus, the martensite steel of the rod has a surface a hardness of more than 41 HRC, preferably 49-55 HRC, more preferably about 50 HRC, while a conventional rod material in the form of hardened steel has a surface hardness within the range of 57-62 HRC.

Advantageously, the material of the sleeve 7 may be a hardened low-alloy steel, for example case-hardened or carburized steel, since the problems with corrosion fatigue in the sleeve are not as critical as the problems with such fatigue in the thread-groove bottoms of the drill rod.

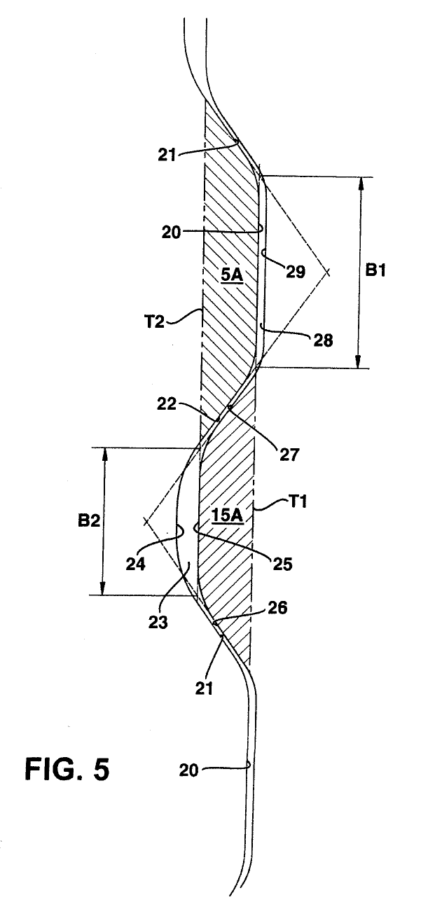

Reference is now made to FIG. 5, which on an enlarged scale illustrates the two helix thread ridges 5A, 15A that form the male thread and the female thread, respectively. The male thread ridge 5A has a profile shape that is defined by a crest 20 and two flanks 21, 22, which delimit a groove 23 that has a bottom 24 and, like the proper ridge, extends helically along the rod. In this case, the profile shape is symmetrical by the fact that the flanks 21, 22 are inclined at equally large angles. In the example, the thread ridge crest 20 has the shape of a helix surface having a width B1 that determines the cross-sectional area of the thread ridge 5A. The cross-sectional area of the thread ridge 5A of the male thread 5 is calculated from a tangent T2 of the crest 20 of the female thread 15, while the cross-sectional area of the thread ridge 15A of the female thread 15 is calculated from a tangent T1 of the crest 25 of the male thread 5, such as the same are represented by the shaded fields in FIG. 5. Furthermore, the groove bottom 24 of the male thread has a smoothly rounded cross-sectional shape, which substantially is defined by an arc line. The cross-sectional area of the thread ridge 5A is larger than the imaginary cross-sectional area of the groove 23. The imaginary cross-sectional area of the groove 23 is determined by the area between the tangent T1, the bottom 24 and the flanks 21 and 22.

In the same way as the male thread ridge 5A, the female thread ridge 15A is delimited by a crest 25 and two flanks 26, 27, between which a helix groove 28 having a bottom 29 is delimited. In the example, said groove bottom 29 is defined by a straight generatrix. The crest 25 of the female thread ridge has a width B2 that may be smaller than the width B1 of the crest surface 20. This means that the cross-sectional area of the female thread ridge 15A may be smaller than that of the male thread ridge, from which it follows that the wear volume of the male thread ridge may be larger than the wear volume of the female thread ridge. In the example, the wear volume of the female thread ridge 15A amounts to about 81.8% of the wear volume of the male thread ridge. In other words, the wear volume of the male thread ridge is about 22% larger than the wear volume of the female thread ridge. However, this proportion between the respective wear volumes may vary most considerably, above all depending on the choice of material of the rod and the coupling sleeve, respectively. More precisely, the greater the difference in wear resistance/surface hardness there is between the stainless steel of the male thread and the hardened steel of the coupling sleeve, proportionally the larger wear volume the male thread ridge 5A may have. Therefore, in practice, the male thread ridge may be given a wear volume that is more than 20 or 25%, e.g., 50-75%, larger than the wear volume of the female thread ridge.

In FIG. 3, A, B, C, D and E designate a number of axially spaced-apart cross-planes, which extend perpendicularly to the centre axis CL of the rod and between which the rod 1 has longitudinal sections of different character. Between the planes A and B, the male thread 5 extends with full thread (with the exception of a tapering entering surface 37 adjacent to the end surface 2). The outer diameter of the thread ridge (counted along the thread crest 20) is designated D1, while D2 designates the inner diameter of the groove bottom 24. Between the planes B and C, a generally cylindrical envelope surface 30 extends, in which the thread groove 23 runs out. The envelope surface 30 may advantageously have the same diameter as the outer diameter D1 of the thread 5. Furthermore, between the planes C and D, a rotationally symmetrical, more precisely cylindrical guide surface 31 is delimited, which has a diameter D3 that is larger than the diameter of the envelope surface 30 and thereby also larger than the outer diameter D1 of the thread. Said guide surface 31 is formed between the male thread and a tapered waist or reduction 32, which extends between the cross-planes D and E. Approximately halfway between the cross-planes D and E, the waist 32 has a smallest diameter D4, which advantageously is at most as large as the inner diameter D2 of the male thread 5. Suitably, the smallest diameter D4 of the waist 32 is even somewhat smaller than the diameter D2 of the thread-groove bottom. The waist 32 transforms into the guide surface 31 and the hexagonal main section 3, respectively, via concavely arched, successively expanding transition surfaces 33, 34. Alternatively, the hexagonal main section may be a round section.

The hexagon shown in FIG. 4, which forms the main section S of the drill rod, has a cross-sectional area determined by the width dimension H between two diametrically opposed, planar surfaces. The inner diameter of the flush duct 4, which is designated D5, is considerably smaller than the dimension H.

The axial lengths of the different bar sections are designated L1, L2, L3 and L4. In FIG. 3, it is seen that the length L1 of the thread 5 is greater than the length L2 of the envelope surface 30, which in turn is greater than the length L3 of the guide surface 31. Just the guide surface 31 has a limited length L3. More precisely, the guide surface 31 may be considerably shorter or thinner than the envelope surface 30 in which the thread groove runs out. The guide surface 31 of the drill rod 1 has a diameter D3 that is at least twice as large as the axial length L3 thereof. The length L4 of the waist 32 may advantageously be only somewhat smaller than the length L1 of the full-profile thread.

In one practical embodiment, the male thread 5 has a length L1 of 75 mm and an outer diameter D1 of 38.7 mm, while the inner diameter D2 of the thread-groove bottom amounts to 34 mm. This means that the male thread ridge has a height of about 2.3 mm. The envelope surface 30 may have a length L2 of 17 mm and a diameter of 38.7 mm, i.e., the same diameter as the outer diameter D1 of the thread. However, the guide surface 31 has a diameter D3 that is larger than the diameter D1 and, in the practical example, amounts to 39.1 mm. In other words, the diameter difference between the guide surface 31 and the envelope surface 30 amounts to 0.4 mm. The axial extension L3 of the guide surface 31 may then be limited to 7 mm. In the example, the smallest diameter D4 of the waist 32 amounts to 32.9 mm. In other words, in this case the diameter D4 is about 1.1 mm smaller than the diameter D2 of the thread-groove bottom. The axial length L4 of the waist amounts to about 57 mm.

The coupling sleeve 7 (see FIG. 2) may be formed with an internal guide surface 35 positioned between the female thread 15 and the free end 11 of the sleeve, for the co-operation with the external guide surface 31 of the drill rod. Said guide surface 35 is also rotationally symmetrical, preferably cylindrical, the same having a diameter D6 that is only somewhat larger than the diameter D3 of the guide surface 31. The guide surface 35 has an axial length L6, which is greater than the thickness L5 of the partition wall 10. In the practical embodiment example, D6 amounts to 39.2 mm, which means that the gap between the surfaces 31, 35 amounts to only 0.05 mm. In other words, the fit between the guide surfaces 31, 35 is fine.

Between the guide surface 35 and the end surface 11 of the sleeve, a chamfer 36 is formed in order to facilitate the insertion of the drill rod into the sleeve.

When the male thread 5 of the drill rod is screwed into the female thread 15 of the sleeve into full engagement with the end surface 2 pressed against the wall surface 18, the guide surface 31 is located in the immediate vicinity of the chamfer 36. In other words, in this state the guide surface 31 is maximally axially spaced apart from the partition wall 10 of the coupling sleeve. This means that possible tendencies of the drill rod to deflect or turn inside the sleeve are efficiently counteracted by the co-operating guide surfaces 31, 35.

By the fact that the waist 32, which is arranged axially inside the male thread 5, has a reduced diameter, a flexibility or elastic compliance is obtained in comparison with the hexagonal main profile S as well as the different sections closer to the end of the rod, which are thicker than the waist. This means that the deflection tendencies of the drill rod, which inevitably arise during practical drilling, are absorbed by the elastic waist rather than propagating to the threaded joint between the drill rod and the sleeve.

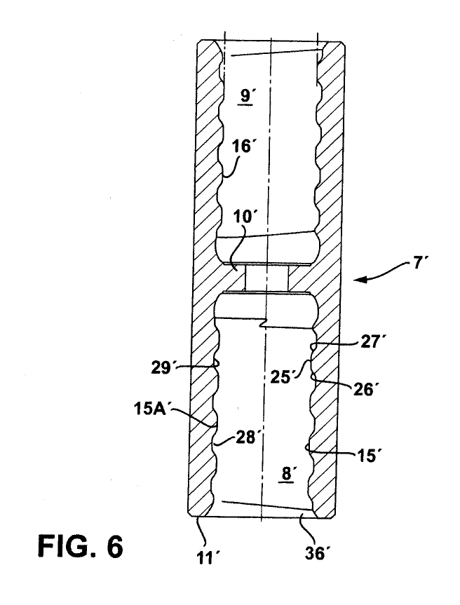

In FIG. 6, an alternative embodiment of a coupling sleeve 7′ according to the present invention is shown, the coupling sleeve 7′ differing from the sleeve described in FIG. 2 foremost in that a first female thread 15′ connects directly to the end surface 11′ or to a chamfer 36′ without any intermediate guide surface, and in that the wear volume of the first female thread 15′ is smaller than the wear volume of a second female thread 16′. Hence, the coupling sleeve 7′ comprises two hollow spaces 8′, 9′, which terminate in opposite directions and are separated by a partition wall 10′, and in which female threads 15′, 16′ are formed. The first female thread 15′ is a thread ridge 15A′ having a crest 25′ and two flanks 26′, 27′ that delimit a helix groove 28′ having a bottom 29′. The width of the thread ridge is smaller than the width of the groove. The second female thread 16′ is a thread ridge having a crest and two flanks that delimit a helix groove having a bottom. The width of the thread ridge of the first female thread 15′ is smaller than the width of the thread ridge of the second female thread 16′.

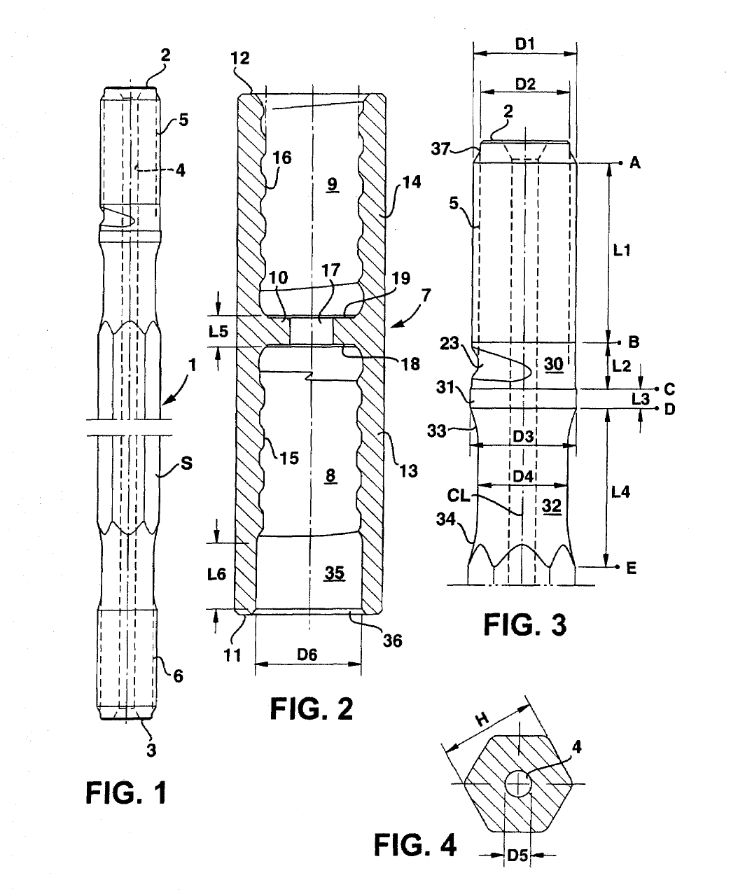

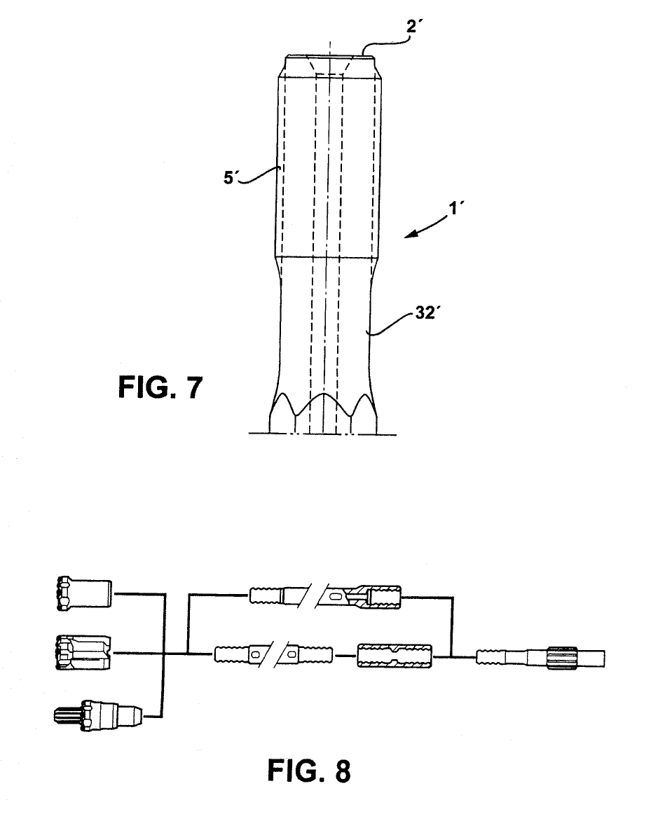

In FIG. 7, an alternative embodiment is shown of a shank end of a drill rod 1′ according to the present invention, the drill rod 1′ differing from the drill rod described in FIGS. 1 and 3 foremost in that the waist 32′ substantially connects directly to the male thread 5′ without any intermediate guide surface. The free end 2′ is intended to be received in the hollow space 8′ in the sleeve 7′.

A fundamental advantage of the drilling tool according to the invention composed of the drill rod, the coupling sleeve and a bit, is that the same has optimised properties in respect of service life (different wear volumes of the threads) as well as technical performance. Where appropriate, the use of the martensitic, stainless steel in the male thread of the drill rod accordingly counteracts corrosion fatigue therein to a far-reaching extent. Simultaneously, it is guaranteed that the expensive drill rod obtains at least as long service life as the cheaper coupling sleeve. Last, but not at least, the flexible waist provides the effect that the deflection motions of the drill rod are absorbed in the waist, without propagating into the threaded joint.

Even if the invention above has been described in connection with a rock-drilling tool that is intended for drifter drilling and comprises only one drill rod and one coupling sleeve, the same is also applicable to rock-drilling tools having two or more rods and coupling sleeves, respectively.

The disclosures in Swedish patent application Nos. 0601117-5 and 0601119-1, from which this application claims priority are incorporated herein by reference.

The invention is in no way limited to the above-described embodiments but can be freely varied within the limits of the appended claims.

1. A rock-drilling tool comprising a drill rod having a male thread, and a coupling sleeve having a female thread for the co-operation with the male thread of the drill rod, wherein that the male thread of the drill rod may consist of a martensitic, stainless steel, in that the coupling sleeve consists of hardened low-alloy steel, and in that a waist is formed axially inside the male thread, in which waist the drill rod has the smallest diameter thereof, and wherein the male thread has a wear volume that is larger than the wear volume of the co-operating female thread.

2. Rock-drilling tool according to claim 1, wherein the drill rod comprises a male thread that is formed adjacent to a free end and in the form of a helix thread ridge having a crest and two flanks that delimits a likewise helix groove having a bottom, the wear volume of the male thread ridge being at least 20% larger than the wear volume of a corresponding female thread ridge of the female thread.

3. Rock-drilling tool according to claim 1, wherein the wear volume of the male thread ridge of the male thread is at least 22% larger than the wear volume of the female thread ridge.

4. Rock-drilling tool according to claim 1, characterized in that wherein the content of martensite in the stainless steel amounts to at least 50% by weight.

5. Rock-drilling tool according to claim 1, wherein the waist substantially connects directly to the male thread.

6. A drill rod for rock-drilling tools, comprising a make thread that is formed adjacent to a free end and in the form of a helix thread ridge having a crest and two flanks that delimits a likewise helix groove having a bottom, the groove having an imaginary cross-sectional area, wherein said male thread may consist of a martensitic, stainless steel, in that a waist is formed axially inside the male thread, in which waist the drill rod has the smallest diameter thereof, and wherein the thread ridge of the male thread has a cross-sectional area that is larger than the imaginary cross-sectional area of the groove.

7. Drill rod according to claim 6, wherein the cross-sectional area of the male thread ridge is at least 20% larger than a cross-sectional area of a corresponding female thread ridge of the female thread.

8. Drill rod according to claim 6, wherein, the wear volume of the male thread ridge of the male thread is at least 22% larger than the wear volume of the female thread ridge.

9. Drill rod according to claim 6, wherein the content of martensite in the stainless steel amounts to at least 50% by weight.

10. A coupling sleeve for rock-drilling tools, the coupling sleeve comprising two hollow spaces, which terminate in opposite directions and are separated by a partition wall, and in which female threads are formed, that wherein a first female thread is a thread ridge having a crest and two flanks that delimit a helix groove having a bottom, the width of the thread ridge being smaller than the width of the groove, and wherein in that a second female thread is a thread ridge having a crest and two flanks that delimit a helix groove having a bottom, the width of the thread ridge of the first female thread being smaller than the width of the thread ridge of the second female thread.

11. Rock-drilling tool according to claim 2, wherein the wear volume of the male thread ridge of the male thread is at least 22% larger than the wear volume of the female thread ridge.

12. Rock-drilling tool according to claim 4, wherein the content of martensite in the stainless steel amounts to at least 75% by weight.

13. Drill rod according to claim 7, wherein the wear volume of the male thread ridge of the male thread is at least 22% larger than the wear volume of the female thread ridge.

14. Drill rod according to claim 13, wherein the content of martensite in the stainless steel amounts to at least 50% by weight.

15. Drill rod according to claim 14, wherein the content of martensite in the stainless steel amounts to at least 75% by weight.

16. Drill rod according to claim 9, wherein the content of martensite in the stainless steel amounts to at least 75% by weight.

17. Drill rod according to claim 7, wherein the content of martensite in the stainless steel amounts to at least 50% by weight.

18. Drill rod according to claim 17, wherein the content of martensite in the stainless steel amounts to at least 75% by weight.

19. Drill rod according to claim 8, wherein the content of martensite in the stainless steel amounts to at least 50% by weight.

20. Drill rod according to claim 19, wherein the content of martensite in the stainless steel amounts to at least 75% by weight.
